(19) United States
(12) Patent Application Publication
(10) Pub. No.: US 2016/0222919 A1
(43) Pub. Date: Aug. 4, 2016

(54) TURBOPUMP FOR A ROCKET ENGINE HAVING A RADIAL STAGE

(71) Applicant: Airbus DS GmbH, Taufkirchen (DE)

(72) Inventor: Chris MAEDING, Unterschleissheim (DE)

(21) Appl. No.: 15/014,939

(22) Filed: Feb. 3, 2016

(30) Foreign Application Priority Data
Feb. 4, 2015 (DE) 10 2015 001 271.1

(51) Int. Cl. F02K 9/46; F02K 9/62; F02K 9/42

(52) U.S. Cl. CPC F02K 9/46; F02K 9/425; F02K 9/62; F05D 2220/80

(57) ABSTRACT

A turbopump for a rocket engine includes a radial pump having a wheel with vanes in a central body that is essentially rotationally symmetrical. The central body includes two separate outflow areas for one propellant component of the rocket engine, where a first portion of the propellant component is conveyed through a first of the outflow areas into a rocket combustion chamber and a second portion of the propellant component is conveyed through a second of the outflow areas into a gas generator. The first outflow area and the second outflow area have different geometric dimensions such that the propellant component in the first outflow area can be provided at a first propellant throughput and at a first exit pressure that differ from a second propellant throughput and a second exit pressure of the second outflow area.

### CROSS REFERENCES TO RELATED APPLICATIONS

This application claims priority under 35 U.S.C. §119 from German Patent Application No. 10 2015 001 271.1, filed Feb. 4, 2015, the entire disclosure of which is herein expressly incorporated by reference.

### FIELD OF THE INVENTION

The invention relates to a turbopump for a rocket engine having a radial pump that includes a wheel with vanes in a central body embodied essentially rotationally symmetrical.

### BACKGROUND

Radial pumps convey and increase the pressure of an operating medium for ensuring operational conditions in a rocket combustion chamber of the rocket engine. In rocket engines that work according to the so-called staged combustion or closed cycle method, some of one of two propellant components (a fuel or an oxidizer) is added to a pre-combustion chamber to provide combustion of the propellant component in a lean or rich mixture at moderate fuel gas temperature. The pre-combustion chamber is also called the gas generator or pre-burner. To minimize the turbine power required for driving an oxidizer pump and a fuel pump of the staged combustion engine, the small portion of propellant component required for the pre-combustion chamber is conducted via a small, additional pump stage of the force pump in which it undergoes the increase in pressure necessary for injection into the pre-combustion chamber.

Typically the pre-combustion chamber is operated at a combustion chamber pressure that is increased at least by the turbine expansion ratio and also the line pressure losses in the system area of the pre-combustion chamber up to entry into the primary combustion chamber of the rocket engine. The portion of the propellant component that is needed for the pre-combustion chamber must have this pressure level at the exit of the additional pump stage (kick stage). The main portion of this propellant component is conducted into the primary combustion chamber of the rocket engine, however, and must therefore not have this level of pressure that is used for supplying the pre-combustion chamber.

Although providing an additional pump stage (kick stage) makes it possible to minimize the required turbine power of the pump, due to the low mass throughput its efficiency is relatively low. In addition, there is the need for arranging an additional rotating component and the line from the oxidizer pump or the fuel pump that is needed for this, depending on whether the gas generator is operated lean or rich.

U.S. Pat. No. 6,226,980 B1 discloses a liquid-propellant rocket engine that works according to the principle of the staged combustion method described in the foregoing. It has a primary combustion chamber and a turbopump unit that includes a two-stage fuel pump (comprising main pump and booster pump) and a single-stage oxidizer pump, as well as a pre-combustion chamber (gas generator). The two-stage fuel pump and the single-stage oxidizer pump are driven by a turbine of a turbopump unit.

### SUMMARY OF THE INVENTION

It is an object of the present invention to provide a turbopump for a rocket engine that is improved structurally and/or functionally with respect to use in a rocket engine and that works using the staged combustion method.

A turbopump for a rocket engine having a radial stage is suggested, which radial pump includes a wheel with vanes (blades) in a central body embodied essentially rotationally symmetrical. The central body includes two separate outflow areas for one propellant component of the rocket engine. A first portion of the propellant component may be conveyed through a first of the outflow areas into a rocket combustion chamber and a second portion of the propellant component may be conveyed through a second of the outflow areas into a gas generator. The gas generator is also called a pre-burner. The first outflow area and the second outflow area have different geometric dimensions, so that the propellant component in the first outflow area can be provided at a first propellant throughput and at a first exit pressure that differ from a second propellant throughput and a second exit pressure of the second outflow area.

Since in the radial stage the functionality or components of a main propellant pump and an additional pump (the so-called booster stage) are combined in one component, the result is a design simplification, a reduction in the number of rotating components, and the possibility of increasing the efficiency of the force pump.

The underlying principle of the invention is to conduct, by means of a single wheel, the propellant component of the rocket engine that is conducted by the wheel into different outflow areas that are fluidically connected on the one hand to the rocket combustion chamber and on the other hand to the gas generator.

In accordance with one embodiment, the wheel may include a partial cover plate arranged radially exteriorly by which the propellant component is divided into the first portion and the second portion. By providing the partial cover plate that is arranged radially with respect to the wheel, two outflow areas that are separated from one another are produced, through which each of the propellant components may be conveyed to the rocket combustion chamber and the gas generator at the required exit pressures and at the required propellant throughputs.

The partial cover plate may be provided on the wheel as an integral component of the wheel. In this description, “integral component” shall be construed to mean both a one-piece embodiment of the two components and also a positive and/or non-positive connection of the two components.

Due to its design and/or the geometric arrangement in the central body, the partial cover plate establishes the exit widths of the first and second outflow areas, so that the exit diameters of the first and second outflow areas may be established for providing prespecified conveyance levels and/or exit pressures in the first and second outflow areas. The partial cover plate is thus arranged and embodied in accordance with the requirements of the specific rocket engine.

In particular, a first exit diameter of the first outflow area, through which the propellant component is conveyed into the rocket combustion engine, is larger than a second exit diameter of the second outflow area, through which the propellant component may be conveyed in the gas generator. As described, the exit diameters are established by the geometric arrangement and embodiment of the partial cover plate.

It is useful when the vanes of the wheel in the first outflow area are shorter than the vanes of the wheel in the second outflow area.—The specific conveyance level of the propellant components is determined using the different diameters of the vanes. The conveyance level corresponds to the exit pressure of the propellant components and is a function of the requirements of the rocket fuel chamber and of the gas generator. The vane height at the exit, in conjunction with the exit angle and the diameter of the vanes, has a certain effect on the conveyance level. In the suggested radial wheel, initially a radial stage is embodied corresponding to the requirements for conveyance level for the gas generator. Then the width is reduced to the desired throughput at the exit. Then, for supplying the combustion chamber, the outflow edge is positioned corresponding to the given vane angle, the required conveyance level for supplying the combustion chamber, and the associated throughput.

In the first outflow area, the vanes of the wheel in the first outflow area may be continued in shape and number continuously into the second outflow area. In this way the wheel may be provided with less complexity.

It is furthermore useful when the partial cover plate has a segment extending radially that extends into a radial slot of the vanes and divides them at their radially outer end into a first partial vane segment and into a second partial vane segment, wherein the first partial vane segment runs in the first outflow area and the second partial vane segment runs in the second outflow area. The partial cover plate and the wheel thus engage in one another (without touching one another), which makes it easier to provide the prespecified conveyance levels and/or exit pressures in the first and second outflow areas.

It is furthermore useful when the partial cover plate is provided in the area of its outer diameter with a circumferential seal that is adjacent to the central body, so that there is a physical separation of the propellant components in the first and second outflow areas. Because of this there is reduced interaction of the propellant flows in the first and second outflow areas. Some undesired effects of such an interaction may therefore be prevented.

The outflow area opens into a first volute outlet. Similarly, the second outflow area opens into a second volute outlet that is smaller in comparison to the first outlet volute. Volute outlets are spiral-shaped housings with any diameter.

In accordance with another embodiment, an outflow area of the radial stage is coupled to a forepump through which the propellant component may be conveyed into the radial pump. This can improve the cavitation of the turbopump.

Additional features, advantages and possible applications of the invention follow from the following description of the exemplary embodiments and figures. All of the described and/or graphically illustrated features constitute the subject matter of the invention alone or in any combination, even independently of their composition in the individual claims or their back-references.

### BRIEF DESCRIPTION OF THE FIGURES

FIG. 1 is a simplified diagram of the flow in a conventional staged combustion engine;

FIG. 2 is a sectional view of the turbopump depicting a typical flow path when using a turbopump, which includes a main pump and an additional pump (booster stage) for one of the propellant components;

FIG. 3 is a partial cut-away, perspective view of the structure of an inventively embodied radial stage of a turbopump for a rocket engine;

FIG. 4 is an enlargement of a detail of a wheel of the radial stage from FIG. 3;

FIG. 5 depicts the flow in an inventive radial stage in an enlargement of the details depicted in FIG. 3;

FIG. 6 is an enlargement of the outflow areas provided in the inventive radial stage;

FIG. 7 is a partial cut-away, perspective depiction of the inventive radial stage, from which the form of the vanes of the wheel may be seen; and,

FIG. 8 is an enlargement of the partially cut-way radial stage for illustrating the course of the vanes and a partial cover plate of the inventive radial stage.

The figures are schematic and not shown true to scale. If the same reference symbols are shown in the following description in different figures, they designate same or similar elements. However, same or similar elements can also be designated with different reference symbols.

### DETAILED DESCRIPTION OF EXEMPLARY EMBODIMENTS

FIG. 1 is a schematic depiction of a staged combustion engine, i.e. a rocket engine that works according to the principle of the known staged combustion method. The rocket engine includes a primary combustion chamber 1; a turbopump unit 2 comprising a turbine 3, a two-stage propellant component pump 4, and a single-stage propellant component pump 5; a gas generator (pre-burner) 6; and propellant inlets 7 and 8. The rocket engine is operated by means of the propellant components A, e.g. an oxidizer, and B, for instance a fuel. The two-stage propellant component pump 4 includes a main pump 9 and an additional pump 10 that represents a so-called booster stage. The turbine 3 drives the main pump 9, the additional pump 10, and the propellant component pump 5.

The propellant component B is supplied to the propellant component pump 5 via the propellant inlet 8. There is an increase in pressure in the propellant component pump 5. The propellant component A is supplied to the main pump 9 by the propellant inlet 7. The main pump 9 increases the pressure of the propellant component A for directly supplying the mixing head 12 of the primary combustion chamber 1. The portion of the propellant component A that is required for operating the gas generator 6 and that has a higher pressure than the mass flow portion fed into the primary combustion chamber passes through the additional pump 10 (booster stage) for the pressure to be increased. The main pump 9 and the additional pump 10 are connected via a line 15. This mass flow portion is fed into the gas generator 6 via the line 14.

In the gas generator 6, the excess of the propellant component A, which is supplied via the line 14, is precombusted with the propellant component B. Hot gas expands via the turbine 3, which drives the pumps 9, 10 and 5. After it leaves the turbine 3, this hot gas is supplied to the primary combustion chamber 1 for afterburning and generating thrust.

The gas generator 6 is operated with a combustion chamber pressure that is increased by at least the turbine expansion ratio and the line pressure losses in the system area of the gas generator up to entry into the primary combustion chamber 1. In accordance with the drawing in FIG. 1, lines 14, 15, and 16 are to be taken into account for the line pressure losses. This means that the mass flow that is required for the gas generator 6 must have this pressure level at the exit of the additional pump 10. In contrast, the primary portion of the propellant component A that is introduced via the main pump 9 directly into the primary combustion chamber 1 does not have to have this pressure level that is for supplying the gas generator.

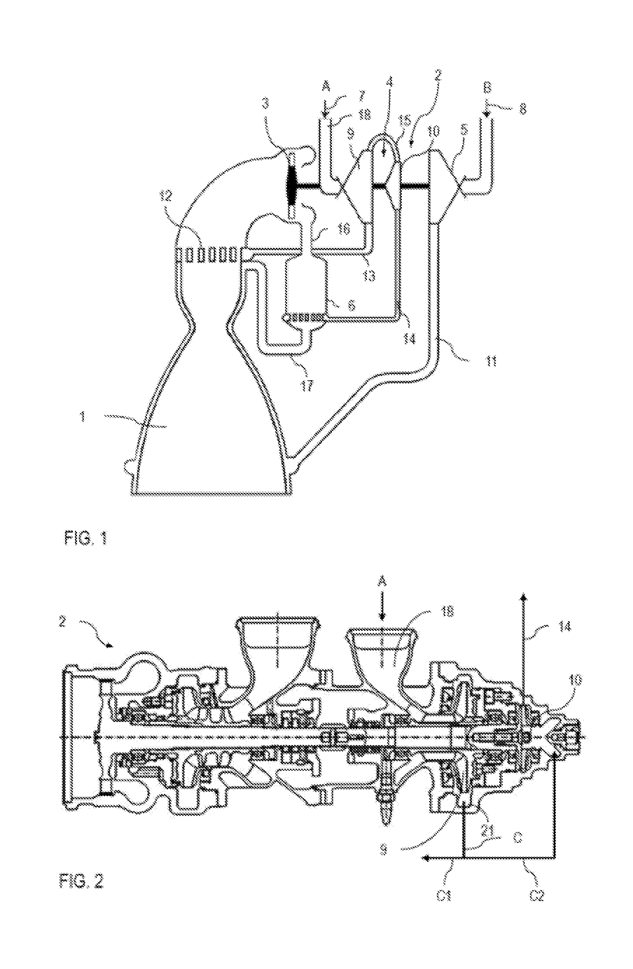

FIG. 2 is a schematic depiction of a cross-section of a conventional turbopump unit 2, wherein the typical flow path when using a main pump 9 and an additional pump 10 (booster stage) is illustrated. The main pump 9 and the additional pump 10 form the two-stage propellant component pump for the propellant component A, which is supplied to the main pump 9 via an inlet 18. In the main stage 9 the pressure is increased corresponding to the requirement of the primary combustion chamber 1, which is also not depicted in FIG. 2. Immediately at the exit from the main stage 9 the total mass flow A is divided into the primary mass flow C1 (via the line 13 in FIG. 1) and the secondary mass flow C2 for supplying the additional pump 10, i.e. the booster stage. The mass flow portion C2 is supplied to the additional pump 10 to further increase the pressure according to the requirements of the gas generator 6 (FIG. 1). The secondary mass flow C2 is supplied at increased pressure to the gas generator 6 via the line 14.

The additional pump 10 is characterized by only moderate efficiency due to the low mass throughput of the mass portion of the secondary mass flow C2. In addition, there is the need for the arrangement of an additional rotating component and the necessary lines (line 15) from the main pump 9.

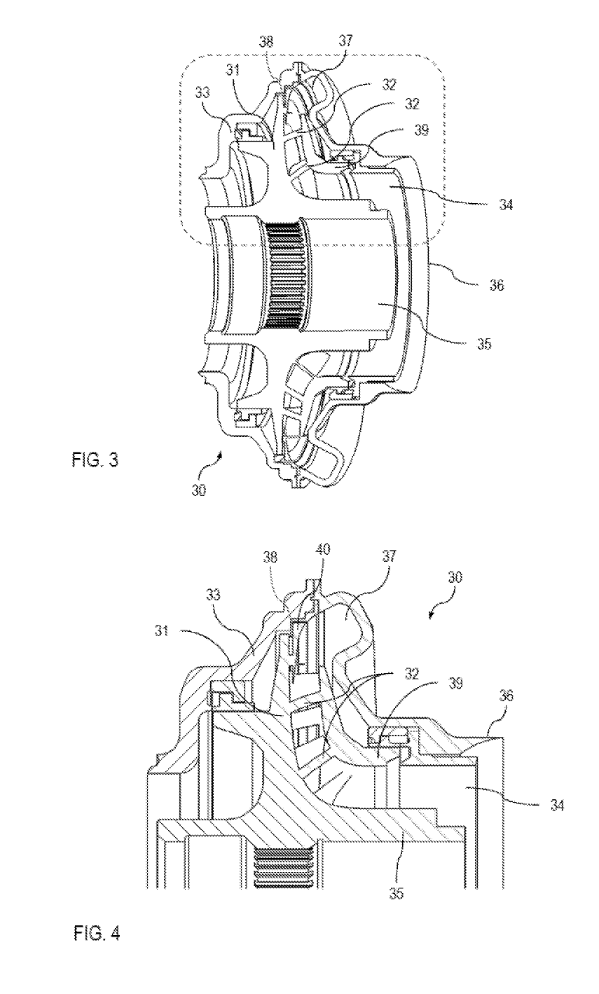

FIG. 3 provides a perspective and cut-away view of an inventive radial pump 30 that in a turbopump unit, as is depicted in FIG. 2, replaces the main pump 9 and the additional pump 10. The radial pump 30 includes a wheel 31 having a number of vanes 32 (also called blades). FIGS. 4 through 6 provide an enlarged depiction of the components of the radial pump 30 that are essential for the invention.

The wheel 31 is arranged in a central body 33 that is essentially embodied rotationally symmetrical. The propellant component A flows via an annular gap 34 formed between a hub contour 35 of the wheel 31 and a cylindrical wall 36 of the central body 33 towards the wheel and is conveyed by the vanes 32 towards a first and a second volute outlet 37, 38. The vanes 32 are connected to one another via a cover plate 39. This creates, between the cover plate 39 and the body of the wheel 31, in conjunction with the vanes or blades 32, channels through which the propellant component A is conveyed towards the volute outlets 37, 38. There is a corresponding increase in pressure due to the vanes or blades 32.

To the exit, the total mass flow C of the propellant component is divided by a partial cover plate 40 into the mass flow portions C1 (primary mass flow) and C2 (secondary mass flow) according to the requirements of the primary combustion chamber and of the gas generator. In addition to dividing the total mass flow C into the primary mass flow C1 and the secondary mass flow C2, the partial cover plate 40 between the two mass flow portions C1 and C2 also reduces excess flow losses. The volute outlets 37, 38 reduce the speed of the mass flow portions C1, C2 at the exit from the radial pump 30 and conduct the mass flow portions to the subsequent components, i.e. the primary combustion chamber and the gas generator. The primary combustion chamber 1 is supplied via the comparatively large volute outlet 37 and the gas generator 6 is supplied via the volute outlet 38.

The volute outlets 37, 38 are designed taking into account e.g. constant circulation and primarily serve to slow the speed and to supply the subsequent lines. The primary dimensions are adapted to speed and throughput. The exit pressures result from the geometry of the radial pump. Since, as described in the foregoing, the pressure for the gas generator 6 must be significantly higher than for the primary combustion chamber 1, the exit diameter of the volute outlet 37, which is connected to the primary combustion chamber 1, is selected to be larger than the exit diameter of the volute outlet 38 that is connected to the gas generator 6.

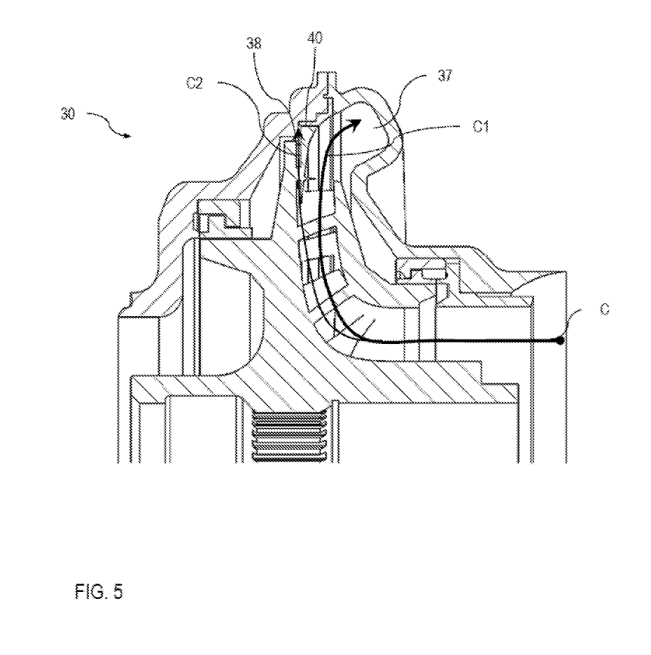

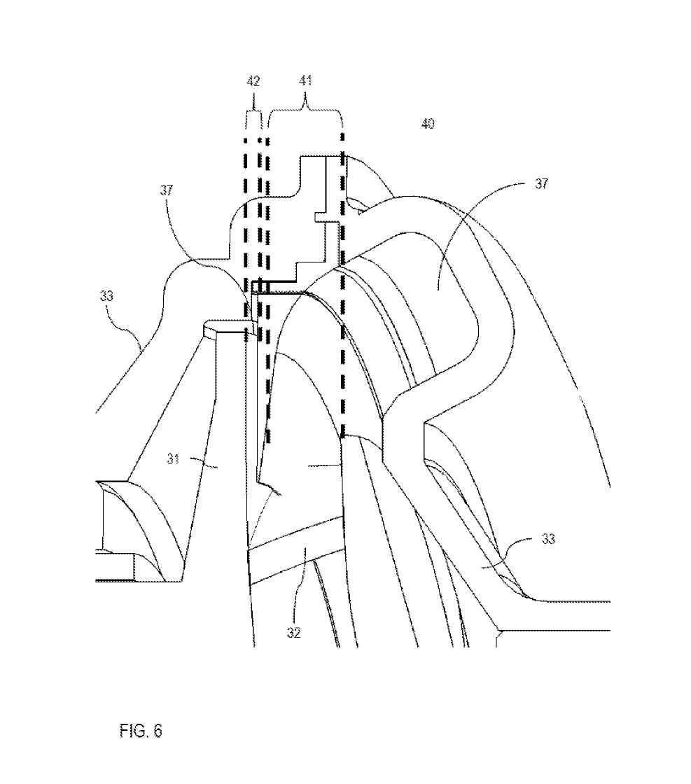

As may easily be seen from the enlargements in FIGS. 4 and 5, the higher exit pressure in the volute outlet 38 is caused by the gap width at the exit 40, at the body of the wheel 31, and at the radius.

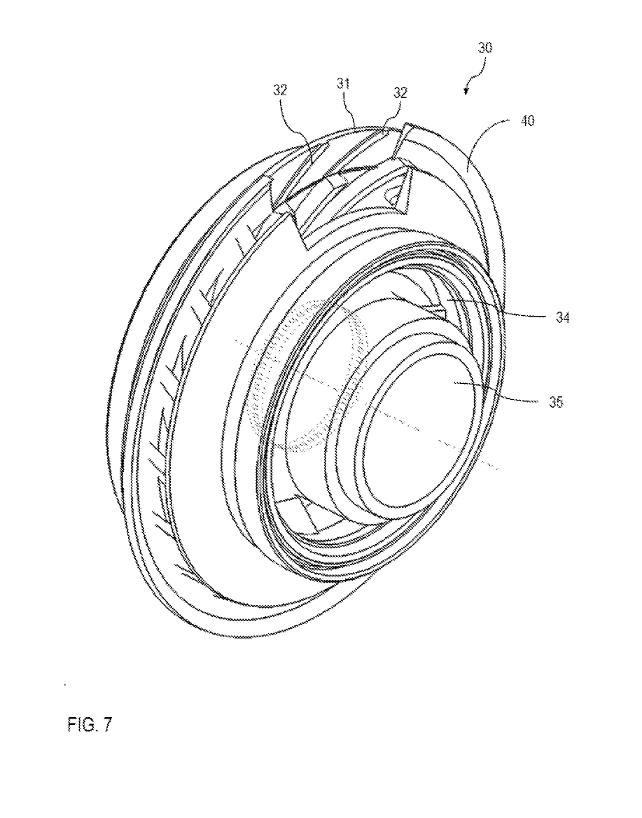

At the exit, immediately prior to leaving the radial pump 30, the total mass throughput C of the propellant component A that is supplied to the radial pump 30 is divided into two mass flows C1, C2 (see FIG. 5) according to the annular gap widths 41, 42 (see FIG. 6). Then the primary mass flow C1 leaves the radial pump 30 via the volute outlet 37. The mass flow C2 needed for supplying the gas generator undergoes the desired additional increase in pressure due to the larger exit diameter of the wheel 31.

The partial cover plate 40 is connected via the vanes to the wheel due to the centrifugal forces. The partial cover plate 40 is connected in a positive and/or non-positive fit to the body of the wheel 31. On its radial outer side, the partial cover plate 40 is provided with a seal against the central body 30 so that the mass flow portions of the conveyed propellant components flowing into the volute outlets 37, 38 do not interact with one another in a disadvantageous manner. Thus, in the aforesaid embodiments the partial cover plate 40 rotates together with the wheel 31.

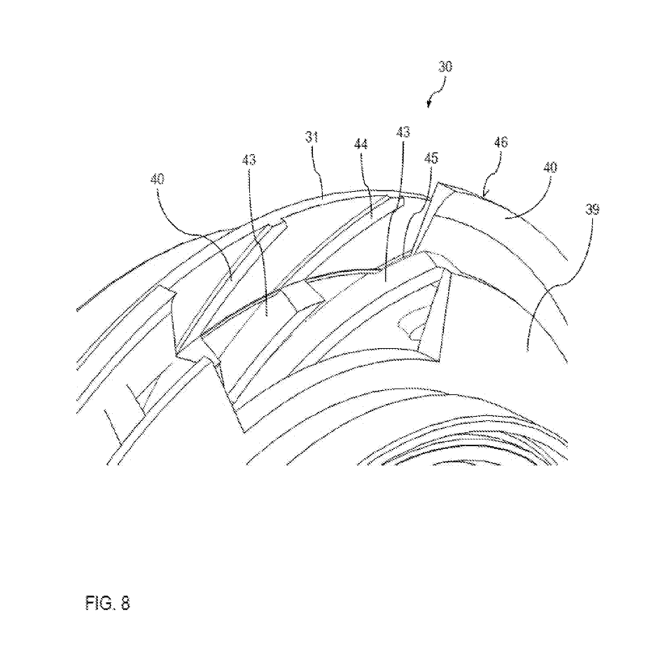

FIGS. 7 and 8 depict one possible embodiment variant of the wheel 31, wherein FIG. 7 provides a perspective, partially cut-away view of the radial pump 30 and FIG. 8 provides an enlargement of the partially cut-away area from FIG. 7. As described, the wheel 31 includes the hub contour 35 with the curved vanes 32. The vanes 32 each comprise a vane segment 43 and a vane segment 44, wherein the vane segments 43 tangentially continue the partial vane segments 43 in the area of the secondary mass flow C2.

As may best be seen from FIG. 8, in a section of the partial cover plate 40 oriented radially to the axis, the vane segments 43, 44 are provided with a gap 45 into which the partial cover plate 40 projects. The partial vane segments 43, which in comparison to the partial vane segments 44 are significantly larger (wider) in the axial direction of the radial pump, convey the primary mass flow C1 of the propellant component, while the partial vane segments 44 convey the secondary mass flow C2 of the propellant component. As may clearly be seen from FIGS. 7 and 8, the mass flow portions C1 and C2 are physically separated via the partial cover plate 40, wherein the outer end face 46 of the partial cover plate 40 is simultaneously used for sealing to the central body 33 (not shown) between the two partial mass flows C1, C2.

The suggested radial pump is much simpler by design compared to a two-stage propellant component pump having a main pump and an additional pump (booster stage). The number of rotating parts is minimized. In addition, it is possible to attain an increase in efficiency compared to the conventional arrangement in a turbopump unit.

In addition, it should be pointed out that “comprising” or “having” do not exclude any other elements, and “a” or “an” does not exclude a plurality. Furthermore, it should be noted that features that have been described with reference to one of the above exemplary embodiments or embodiments can also be used in combination with other features of other exemplary embodiments or embodiments described above. Reference symbols in the claims shall not be regarded as limitations.

### REFERENCE LIST

A Propellant component (oxidizer)
B Propellant component (fuel)
1 Primary combustion chamber
2 Turbopump unit
3 Turbine
4 Two-stage propellant component pump for propellant component A
5 Single-stage propellant component pump for propellant component B
6 Gas generator (pre-burner)
7 Propellant inlet
8 Propellant inlet
9 Main pump
10 Additional pump (booster stage)
11 Line
12 Line
13 Line
14 Line
15 Line
16 Line
17 Line
18 Inlet
19 Line section
30 Radial pump
31 Wheel
32 Vane
33 Central body
34 Annular gap for propellant component to flow into the radial pump (inflow area)
35 Hub contour of wheel 31
36 Cylindrical section of central body 33
37 First volute outlet
38 Second volute outlet
39 Cover plate
40 Partial cover plate
41 Annular gap width for mass flow portion C1
42 Annular gap width for mass flow portion C2
43 Partial vane segment
44 Partial vane segment
45 Gap
46 Outer end face of partial cover plate 40
C Total mass flow of propellant component, e.g. A
C1 Mass flow portion of A for supplying the primary combustion chamber
C2 Mass flow of A for supplying gas generator via the booster stage

What is claimed is:

1. A turbopump for a rocket engine comprising:
a radial pump that includes a wheel with vanes in a central body that is essentially rotationally symmetrical, wherein the central body includes two separate outflow areas for one propellant component of the rocket engine, wherein a first portion of the propellant component is conveyed through a first of the outflow areas into a rocket combustion chamber and a second portion of the propellant component is conveyed through a second of the outflow areas into a gas generator, wherein the first outflow area and the second outflow area have different geometric dimensions such that the propellant component in the first outflow area can be provided at a first propellant throughput and at a first exit pressure that differ from a second propellant throughput and a second exit pressure of the second outflow area.

2. The turbopump in accordance with claim 1, wherein the wheel includes a partial cover plate arranged radially exteriorly by which the propellant component is divided into the first portion and the second portion.

3. The turbopump in accordance with claim 2, wherein the partial cover plate establishes a first exit diameter for the first outflow area and a second exit diameter for the second outflow area, such that the first and second exit diameters of the first and second outflow areas are established for providing at least one of pre-specified conveyance levels and exit pressures in the first and second outflow areas.

4. The turbopump in accordance with claim 3, wherein the first exit diameter of the first outflow area is larger than the second exit diameter of the second outflow area.

5. The turbopump in accordance with claim 1, in which the vanes of the wheel in the first outflow area are shorter than the vanes of the wheel in the second outflow area.

6. The turbopump in accordance with claim 2, in which the vanes of the wheel in the first outflow area are shorter than the vanes of the wheel in the second outflow area.

7. The turbopump in accordance with claim 3, in which the vanes of the wheel in the first outflow area are shorter than the vanes of the wheel in the second outflow area.

8. The turbopump in accordance with claim 1, in which the vanes of the wheel in the first outflow area are continued in shape and number into the second outflow area continuously.

9. The turbopump in accordance with claim 2, in which the vanes of the wheel in the first outflow area are continued in shape and number into the second outflow area continuously.

10. The turbopump in accordance with claim 3, in which the vanes of the wheel in the first outflow area are continued in shape and number into the second outflow area continuously.

11. The turbopump in accordance with claim 2, wherein the partial cover plate has a segment extending radially into a radial slot of the vanes and divides the vanes at their radially outer end into a first and a second partial vane segment, wherein the first partial vane segment runs in the first outflow area and the second partial vane segment runs in the second outflow area.

12. The turbopump in accordance with claim 3, wherein the partial cover plate has a segment extending radially into a radial slot of the vanes and divides the vanes at their radially outer end into a first and a second partial vane segment, wherein the first partial vane segment runs in the first outflow area and the second partial vane segment runs in the second outflow area.

13. The turbopump in accordance with claim 5, wherein the partial cover plate has a segment extending radially into a radial slot of the vanes and divides the vanes at their radially outer end into a first and a second partial vane segment, wherein the first partial vane segment runs in the first outflow area and the second partial vane segment runs in the second outflow area.

14. The turbopump in accordance with claim 1, wherein the partial cover plate comprises a circumferential seal, provided in an area of its outer diameter, that is adjacent to the central body such that there is a physical separation of the propellant components in the first and second outflow areas.

15. The turbopump in accordance with claim 1, wherein the first outflow area opens into a first volute outlet having a first diameter.

16. The turbopump in accordance with claim 15, wherein the second outflow area opens into a second volute outlet having a second diameter that is smaller in comparison to the first diameter of the first volute outlet.

17. The turbopump in accordance with claim 1, wherein an inflow area of the radial pump is coupled to a forepump through which the propellant component may be conveyed into the radial pump.
